(19) United States
(12) Patent Application Publication
(10) Pub. No.: US 2008/0117959 A1
(43) Pub. Date: May 22, 2008

(54) FALSE ALARM REDUCTION IN DETECTION OF A SYNCHRONIZATION SIGNAL

(75) Inventors: Parvanthanathan Subrahmanya, Sunnyvale, CA (US); Vivek Chawla, San Diego, CA (US); Deepali Garg, Boulder, CO (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/937,313

(22) Filed: Nov. 8, 2007

Related U.S. Application Data
(60) Provisional application No. 60/866,882, filed on Nov. 22, 2006.

(51) Int. Cl. H04B 15/00; H04B 3/46

(52) U.S. Cl. 375/224; 375/285

(57) ABSTRACT

Techniques for selectively filtering a received signal in order to reduce false alarms in the detection of a synchronization signal are described. In one design, frequency characteristics of a received signal may be estimated. Large spectral peaks in the estimated frequency characteristics may be detected. Filter coefficients for a pseudo-whitening filter may then be derived based on the detected large spectral peaks. To derive these filter coefficients, a filter gain for each of multiple frequency bins may be set to a predetermined value if a large spectral peak is not detected or a value inversely related to the large spectral peak if detected. The filter gains for all frequency bins may be transformed to time domain and further processed to obtain the filter coefficients. The received signal may be filtered based on the filter coefficients to attenuate the large spectral peaks. The filtered signal may be processed to detect for the synchronization signal.

The present application claims priority to provisional U.S. Application Ser. No. 60/866,882, entitled “WCDMA Step1 False Alarm Reduction Filter,” filed Nov. 22, 2006, assigned to the assignee hereof and incorporated herein by reference.

### BACKGROUND

I. Field

The present disclosure relates generally to communication, and more specifically to techniques for detecting a synchronization signal in a wireless communication system.

II. Background

Wireless communication systems are widely deployed to provide various communication services such as voice, video, packet data, messaging, broadcast, etc. These wireless systems may be multiple-access systems capable of supporting communication for multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include many base stations (or Node Bs) that support communication for many user equipments (UEs). A UE (e.g., a cellular phone) may be within the coverage of zero, one or multiple base stations at any given moment. The UE may have just been powered on or may have lost coverage and thus may not know which base stations can be received. The UE may detect for base stations and acquire timing and other information for the detected base stations.

Each base station may generate a synchronization signal with a known synchronization code and may transmit this signal to assist the UEs perform detection and timing acquisition. A UE may detect for a synchronization signal from a base station by correlating a received signal at the UE with a locally generated synchronization code, comparing the correlation result against a detection threshold, and declaring the presence of the synchronization signal if the correlation result exceeds the detection threshold. The received signal may include interference from other transmitting stations in other wireless systems. A false alarm may occur when the interference in the received signal causes the correlation result to exceed the detection threshold and hence declare the presence of a synchronization signal that is not actually there. The false alarm may result in wasteful additional processing of the received signal, which may extend search time and drain battery power of the UE.

There is therefore a need in the art for techniques to reduce false alarms in the detection of a synchronization signal in a wireless communication system.

### SUMMARY

Techniques for selectively filtering a received signal in order to reduce false alarms in the detection of a synchronization signal are described herein. In an aspect, a UE may detect for large spectral peaks in the received signal. The UE may then attenuate these large spectral peaks, if present, prior to performing detection for the synchronization signal. The synchronization signal may be part of a spread spectrum signal having a relatively flat spectral response. The large spectral peaks may correspond to interference. False alarms may be reduced by attenuating the interference prior to performing detection for the synchronization signal.

In one design, frequency characteristics of the received signal may be estimated. Large spectral peaks in the estimated frequency characteristics of the received signal may be detected. Filter coefficients for a pseudo-whitening filter may then be derived based on the detected large spectral peaks, if any. The pseudo-whitening filter may attempt to make the power spectrum density (PSD) of the received signal more uniform across the system bandwidth by attenuating the large spectral peaks while not emphasizing nulls.

In one design for deriving the filter coefficients, frequency-domain filter gains may be determined based on the detected large spectral peaks. For example, the filter gain for each of multiple frequency bins may be set to (1) a predetermined value if a large spectral peak is not detected in the frequency bin or (2) a value that is inversely related to the magnitude of the large spectral peak if it is detected in the frequency bin. The filter gains for all frequency bins may be transformed to time domain and further processed (e.g., windowed) to obtain the filter coefficients for a finite impulse response (FIR) filter that implements the pseudo-whitening filter. The filter coefficients may have a flat frequency response when large spectral peaks are not detected in the received signal.

The received signal may be filtered by the FIR filter based on the filter coefficients to attenuate the large spectral peaks, if any, in the received signal. The filtered signal may then be processed to detect for a synchronization signal.

Various aspects and features of the disclosure are described in further detail below.

### BRIEF DESCRIPTION OF THE DRAWINGS

FIG. 1 shows a wireless communication system.

FIG. 2 shows transmission of a primary synchronization channel (SCH) and a secondary SCH on the downlink in W-CDMA.

FIG. 3A shows a frequency response of a primary synchronization code (PSC) filter.

FIG. 3B shows PSD of a received signal with a GSM signal as an interferer.

FIG. 4 shows a block diagram of a Node B and a UE.

FIG. 5 shows a block diagram of a signal detector at the UE.

FIG. 6 shows a process for detecting for a synchronization signal.

FIG. 7 shows a process for deriving filter coefficients.

### DETAILED DESCRIPTION

The detection techniques described herein may be used for various communication systems such as CDMA, FDMA, TDMA, OFDMA, and SC-FDMA systems. The terms “systems” and “networks” are often used interchangeably. A CDMA system may utilize a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95, and IS-856 standards. A TDMA system may utilize a radio technology such as Global System for Mobile Communications (GSM). An OFDMA system may utilize a radio technology such as Evolved UTRA (E-UTRA), IEEE 802.16, IEEE 802.20, Flash-OFDM®, etc. UTRA, GSM and E-UTRA are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for W-CDMA, and 3GPP terminology is used in much of the description below.

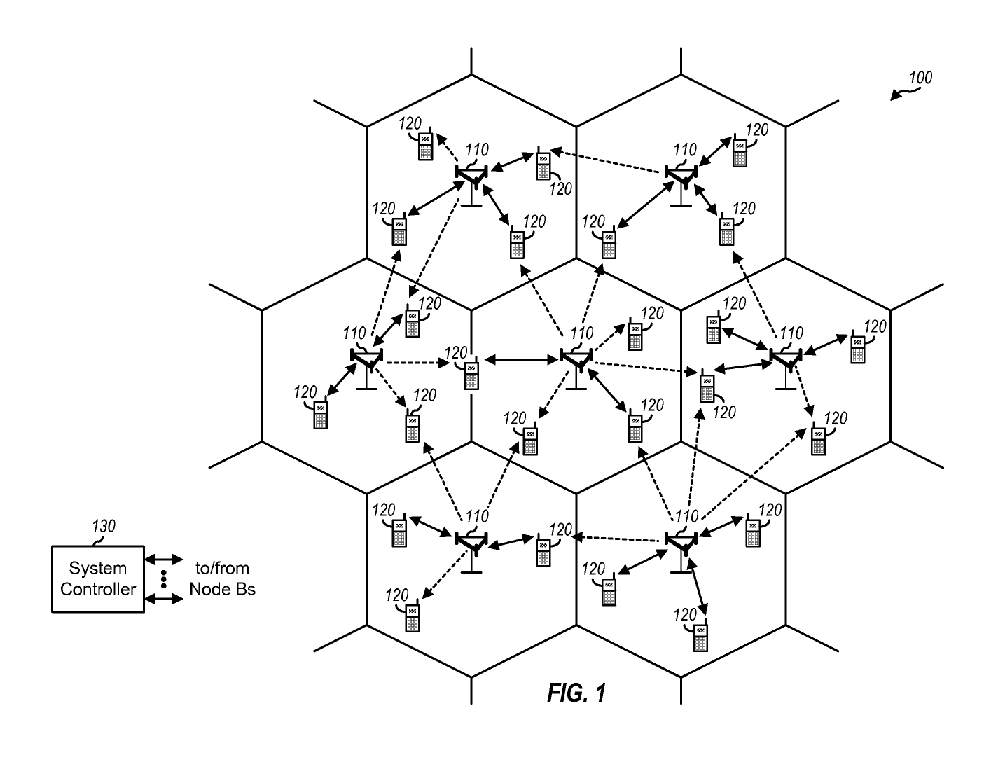

FIG. 1 shows a wireless communication system 100 with multiple Node Bs 110. A Node B is a fixed station that communicates with the UEs and may also be referred to as a base station, an evolved Node B (eNode B), an access point, etc. Each Node B 110 provides communication coverage for a particular geographic area. The term “cell” can refer to a Node B and/or its coverage area depending on the context in which the term is used. The terms “cell” and “Node B” are used interchangeably in the description below.

UEs 120 may be dispersed throughout the system. A UE may be stationary or mobile and may also be referred to as a mobile station, a mobile equipment, a terminal, an access terminal, a subscriber unit, a station, etc. A UE may be a cellular phone, a personal digital assistant (PDA), a wireless communication device, a handheld device, a wireless modem, etc. A UE may communicate with one or more Node Bs via transmissions on the downlink and uplink. The downlink (or forward link) refers to the communication link from the Node Bs to the UEs, and the uplink (or reverse link) refers to the communication link from the UEs to the Node Bs. In FIG. 1, a solid line with double arrows indicates communication between a Node B and a UE. A broken line with a single arrow indicates a UE receiving a downlink signal from a Node B. A UE may perform synchronization based on the downlink signals sent by the Node Bs.

A system controller 130 may couple to Node Bs 110 and provide coordination and control for these Node Bs. System controller 130 may be a single network entity or a collection of network entities. System controller 130 may comprise a Radio Network Controller (RNC), a Mobile Switching Center (MSC), etc.

In W-CDMA, the timeline for transmission on the downlink is divided into radio frames. Each radio frame has duration of 10 milliseconds (ms) and is partitioned into 15 slots. Each slot has duration of 0.667 ms and covers 2560 chips.

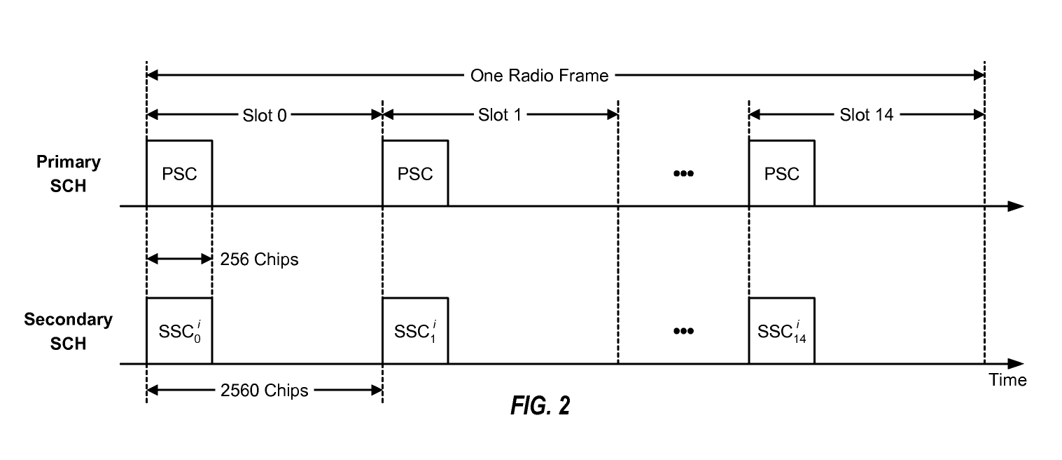

FIG. 2 shows transmission of a primary SCH and a secondary SCH on the downlink in W-CDMA. The primary SCH and secondary SCH are sent in the first 256 chips (or ten percent) of each slot. The primary SCH carries a 256-chip primary synchronization code (PSC) multiplied by a fixed value of either +1 or −1. The PSC is a predetermined sequence of 256 chips. Each Node B in the system transmits the same PSC on the primary SCH.

The secondary SCH carries a sequence of 15 secondary synchronization codes (SSCs) in the 15 slots of each radio frame. This sequence of SSCs is denoted as SSC₀ⁱ through SSC₁₄ⁱ, where i is an index for scrambling code group. Each SSC is a sequence of 256 chips and is selected from a set of 16 predetermined 256-chip codes. There are 64 scrambling code groups. Each scrambling code group includes eight scrambling codes and is associated with a different SSC sequence. Each Node B is assigned a specific scrambling code that is used to scramble data sent by that Node B on the downlink. Each Node B is thus associated with a specific SSC sequence determined by its assigned scrambling code. Each Node B transmits its SSC sequence on the secondary SCH in each radio frame.

A UE may use the PSC to detect for the presence of a Node B and to ascertain the slot timing of that Node B. The UE may determine frame timing and a scrambling code group for the Node B based on the SSC sequence.

A UE may perform acquisition using a three-step process, which is also referred to as step 1-2-3 search. In step 1, the UE may search for the PSC sent on the primary SCH by correlating a received signal (or input samples) at the UE with a locally generated PSC at different time offsets. For each time offset, the UE may correlate the received signal with the PSC at that time offset and declare a PSC peak if the correlation result exceeds a detection threshold. The UE may perform step 2 for each PSC peak detected in step 1. In step 2, the UE may determine the sequence of SSCs used by the Node B for each detected PSC peak. The UE may perform step 3 for each SSC sequence detected in step 2. In step 3, the UE may determine the specific scrambling code used by the Node B for each detected SSC sequence. The UE may evaluate each of the eight scrambling codes associated with the detected SSC sequence to determine the scrambling code used by the Node B.

Step 1 essentially correlates the received signal with the known PSC. This correlation operation is equivalent to filtering the received signal with a PSC filter having the same frequency response as that of the PSC.

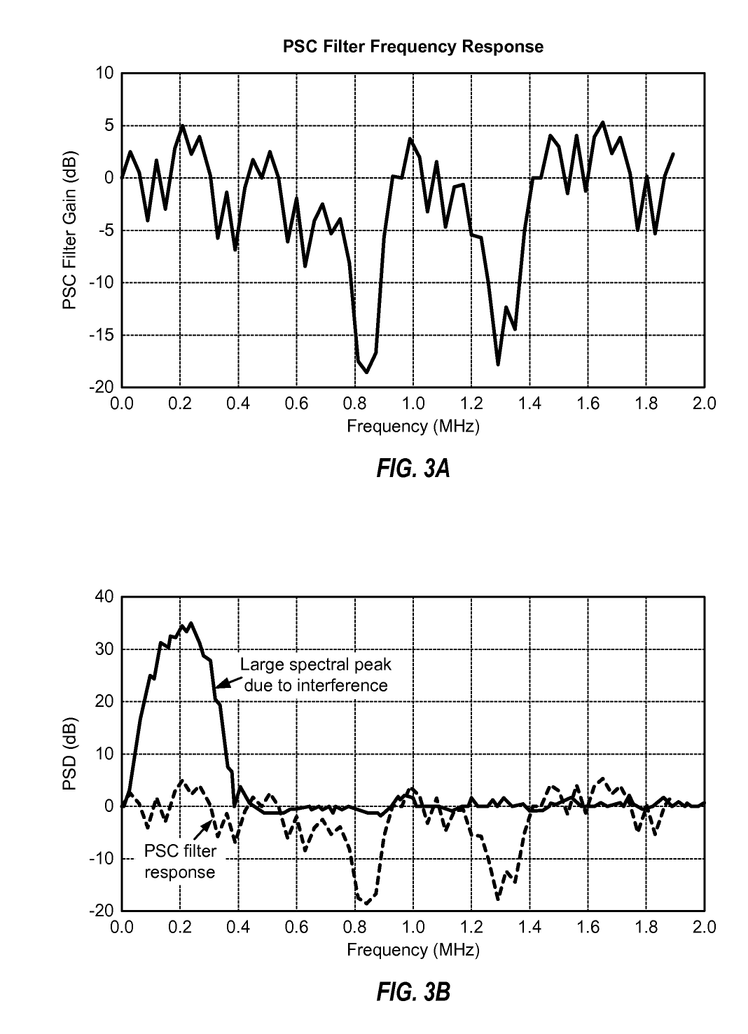

FIG. 3A shows the frequency response of the PSC, and hence the PSC filter. As shown in FIG. 3A, the gain of the PSC filter is not flat across frequency. The PSC filter may amplify spectral components at certain frequencies by 3 to 6 decibels (dB). If interference (e.g., a GSM signal) is present at one of the frequencies with large gain, then the correlation of the received signal with the PSC may exceed the detection threshold, which would then result in a false alarm.

FIG. 3B shows PSD of a received signal that contains a GSM signal as an interferer. As can be seen in FIG. 3B, the GSM signal overlaps a section of the PSC filter response with large gain. The large PSC filter gain amplifies the correlation at the corresponding frequencies and results in high probability of false alarm. When a UE is first powered on or has lost coverage, the UE may search on different frequencies and detect for the PSC at each frequency. Hence, if large amplitude interference is present, then there may be high likelihood of this interference aligning with a high gain section of the PSC filter and causing a false alarm.

False alarms from a step-1 search may extend search time and adversely impact battery life. In operating scenarios where a W-CDMA signal is not present, a UE may spend a considerable amount of time processing false alarms while searching for a suitable cell.

In an aspect, a UE selectively filters a received signal in order to reduce false alarms in the detection of a synchronization signal, e.g., a signal generated with the PSC. The UE may detect for large spectral peaks in the received signal and, if present, may attenuate these large spectral peaks prior to performing detection for the synchronization signal. The synchronization signal may be part of a spread spectrum signal (e.g., a W-CDMA signal) having a relatively flat spectral response. The large spectral peaks may then correspond to interference. In one design, the frequency characteristics of the received signal may be ascertained, and a pseudo-whitening filter may be synthesized based on the frequency characteristics. The pseudo-whitening filter may attempt to make the PSD of the received signal more uniform across the system bandwidth by attenuating large spectral peaks while not emphasizing nulls. The received signal may be filtered with the pseudo-whitening filter, and the filtered signal may be processed to detect for the synchronization signal.

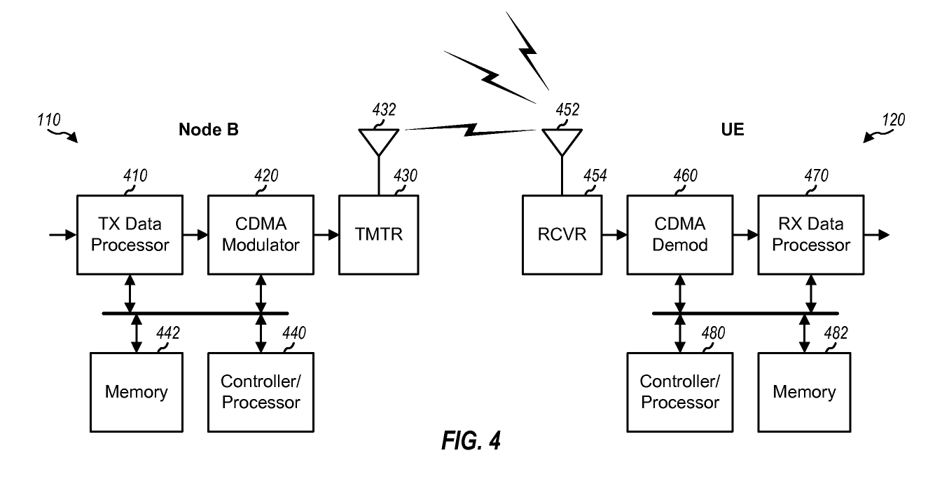

FIG. 4 shows a block diagram of a Node B 110 and a UE 120, which are one of the Node Bs and one of the UEs in FIG. 1. At Node B 110, a transmit (TX) data processor 410 receives traffic data for the UEs being served and processes (e.g., encodes, interleaves, and symbol maps) the traffic data to generate data symbols. Processor 410 also generates signaling symbols for control channels and pilot symbols for a pilot channel. A CDMA modulator 420 processes the data, signaling, and pilot symbols and provides output chips to a transmitter (TMTR) 430. CDMA modulator 420 spreads the symbols for each physical channel with a channelization code for that channel, scales the chips for each physical channel with a gain determined by the transmit power for that channel, sums the scaled chips for all physical channels, and scrambles the combined chips with a scrambling code for Node B 110 to obtain the output chips. The scrambling results in the output chips having an approximately flat PSD. Transmitter 430 processes (e.g., converts to analog, amplifies, filters, and frequency upconverts) the output chips and generates a downlink signal, which is transmitted from an antenna 432.

At UE 120, an antenna 452 receives the downlink signals from Node B 110 and other Node Bs and provides a receiver input signal to a receiver (RCVR) 454. Receiver 454 processes (e.g., filters, amplifies, frequency downconverts, and digitizes) the receiver input signal and provides received samples at a sample rate that may be one or multiple times the chip rate, e.g., twice the chip rate or chip×2. A CDMA demodulator 460 detects for the PSC and SSCs from the Node Bs and provides detected Node Bs and their timing. CDMA demodulator (Demod) 460 also processes the received samples in a manner complementary to the processing by CDMA modulator 420 and provides symbol estimates, which are estimates of the symbols sent by Node B 110 to UE 120. CDMA demodulator 460 may implement a rake receiver and/or an equalizer that can process multiple signal instances in the receiver input signal due to multiple signal paths between Node B 110 and UE 120. A receive (RX) data processor 470 processes (e.g., symbol demaps, deinterleaves, and decodes) the symbol estimates and provides decoded data and signaling. In general, the processing by CDMA demodulator 460 and RX data processor 470 is complementary to the processing by CDMA modulator 420 and TX data processor 410, respectively, at Node B 110.

Controllers/processors 440 and 480 direct the operation of various processing units at Node B 110 and UE 120, respectively. Memories 442 and 482 store data and program codes for Node B 110 and UE 120, respectively.

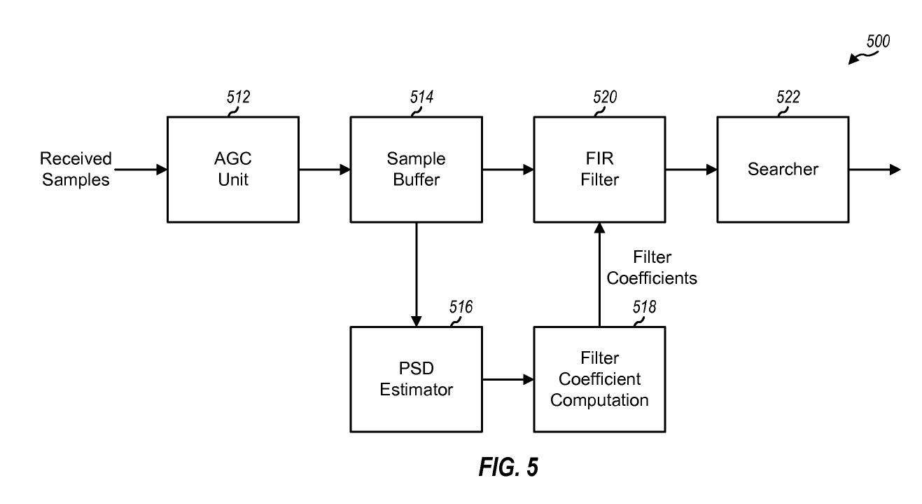

FIG. 5 shows a block diagram of a design of a signal detector 500, which may be part of CDMA demodulator 460 in FIG. 4. Within signal detector 500, an automatic gain control (AGC) unit 512 performs AGC on the received samples from receiver 454 and provides input samples having approximately constant average power. A sample buffer 514 stores the input samples from AGC unit 512. In each time interval (e.g., each slot), buffer 514 provides the input samples for that time interval to a PSD estimator 516 and, after appropriate delay, to a FIR filter 520.

PSD estimator 516 estimates the PSD of the received signal as described below. A computation unit 518 derives filter coefficients for a pseudo-whitening filter based on the estimated PSD, as also described below. In one design, if large amplitude interference is detected in the PSD, then the pseudo-whitening filter has a frequency response that is determined based on the detected interference. If large amplitude interference is not detected in the PSD, then the pseudo-whitening filter has a flat response and is essentially bypassed.

FIR filter 520 implements the pseudo-whitening filter. In each time interval, FIR filter 520 receives the filter coefficients from computation unit 518 and the input samples for that time interval from sample buffer 514. FIR filter 520 filters the input samples based on the filter coefficients and provides filtered samples to a searcher 522. Searcher 522 processes the filtered samples to detect for the PSC and SSCs.

The PSD of the received signal may be estimated in various manners. In one design, the PSD is estimated based on a correlogram method. This method approximates the PSD of the received signal by calculating the DFT of the autocovariance of the signal.

The autocovariance of an input sample sequence for one time interval may be expressed as:

$$r [ i ] = \frac{1}{N} \cdot {\sum }_{n = i}^{N - 1} x [ n ] \cdot {x}^{*} [ n - i ] , \qquad Eq ( 1 )$$

where x[n] is the n-th input sample in the sequence,

r[i] is the autocovariance of the input sample sequence at an offset of i chips,

N is the number of input samples in the sequence, and

“*” denotes a complex conjugate.

In equation (1), index n runs from 0 to N−1, and index i runs from −K/2 to K/2−1, where K≦N. Equation (1) provides a sequence of autocovariance values r[i] of length K. Fewer than N values are accumulated for i>0, but the accumulated results are still divided by N in order to give the autocovariance results for i>0 less weight.

The PSD of the input sample sequence may be expressed as:

$$PSD [ k ] = {\sum }_{i = - K / 2}^{K / 2 - 1} r [ i ] \cdot {e}^{- j \frac{2 π k i}{N}} \cdot {( - 1 )}^{k} , \qquad Eq ( 2 )$$

where PSD[k] is a PSD value for frequency bin k. Index k runs from 0 to K−1, where K is the number of frequency bins for the PSD. Equation (2) essentially performs a K-point discrete Fourier transform (DFT) on the autocovariance of the input sample sequence to obtain the PSD of this sample sequence.

For a given system bandwidth, a larger value of K corresponds to more frequency bins and finer frequency resolution for the PSD. The bin width of the PSD may be expressed as:

$${f}_{bin} = \frac{{f}_{sample}}{K} , \qquad Eq ( 3 )$$

where fₛₐₘₚₗₑ is the sample rate and f_{bin} is the bin width.

In one design, each time interval is equal to one slot, and the autocovariance and PSD are computed based on N=2560 complex-valued input samples at the chip rate, or chip×1. A time interval of some other duration may also be used. In one design, K=32 and each frequency bin has a width of 120 KHz for a chip rate of 3.840 megachips/second (Mcps) in W-CDMA. Other values of K may also be used. A larger K value improves frequency resolution and allows for detection of interference of narrower bandwidth, albeit at the expense of more computation.

In another design, the PSD is estimated based on a periodogram method. In this method, the input samples are first transformed to the frequency domain with a DFT to obtain frequency-domain symbols. The PSD is proportional to the square magnitude of the frequency-domain symbols. The PSD may also be estimated based on other methods. In any case, PSD estimator 516 provides a K-point PSD of the input sample sequence in each time interval.

Computation unit 518 detects for large interference peaks in the PSD. To identify these peaks, unit 518 may estimate the mean of the PSD, not including the peaks, which is referred to as the “floor” of the PSD. Since large peaks are of interest, most of the PSD may be assumed to form the floor, and only the top few PSD values may potentially be peaks. In one design, the PSD floor is estimated based on the mean of the lowest 70% of the PSD values, in linear unit. The PSD floor may also be estimated based on more or fewer PSD values. Unit 518 may then determine a threshold based on the PSD floor. In one design, the threshold is equal to the PSD floor times a predetermined factor, as follows:

PSD_{threshold}=PSD_{floor}·PSD_{offset}, Eq (4)

where PSD_{floor} is the floor of the PSD,

PSD_{offset} is a predetermined value, and

PSD_{threshold} is the threshold used to detect for large interference peaks.

PSD_{offset} determines how large a spectral component needs to be in order to be declared as an interference peak. PSD_{offset} may be equal to 4 in linear unit (which is approximately 6 dB in log unit) or some other value.

Unit 518 may compare each PSD value against the threshold and declare a large interference peak if the PSD value exceeds the threshold. If the threshold is equal to the PSD floor plus 6 dB, then a large interference peak is considered to be present in each frequency bin in which the PSD value is more than 6 dB, or 4 times, higher than the PSD floor. Large interference peaks in the PSD may also be detected in other manners.

Unit 518 may determine frequency-domain filter gains based on the detected interference peaks in the PSD such that these peaks are attenuated, e.g., to the median of the PSD, which may be computed based on all PSD values. In one design, the filter gains are derived as follows:

$$G [ k ] = \{ \begin{matrix}{PSD}_{median} / PSD [ n ] & if PSD [ n ] > {PSD}_{threshold} \\ 1 & otherwise\end{matrix} \qquad Eq ( 5 )$$

where PSD_{median} is the median of the PSD, and

G[k] is the filter gain for frequency bin k.

In the design shown in equation (5), the filter gain G[k] is determined for each frequency bin k based on the PSD value for that bin. The filter gain is less than one and inversely proportional to the PSD value when a large interference peak is detected and is equal to one when a large interference peak is not detected. Unlike a whitening filter, the frequency response of the pseudo-whitening filter in equation (5) is not the inverse of the PSD since it attenuates prominent peaks but does not emphasize nulls in the PSD.

Unit 518 may transform the K filter gains for the K frequency bins to the time domain with a K-point inverse DFT (IDFT) to obtain K time-domain values. The PSD and filter gains may be derived based on input samples at one rate (e.g., chip×1), and filtering may be performed on input samples at another rate (e.g., chip×2). In this case, the time-domain values may be interlaced with zeros, if necessary. For example, if the filter gains are derived based on chip×1 samples and the filter coefficients are applied to chip×2 samples, then a zero may be inserted between each pair of consecutive time-domain values to obtain 2K total time-domain values.

Unit 518 may apply windowing to the 2K time-domain values to reduce spectral leakage and obtain 2K filter coefficients. The windowing may be performed based on any window such as a raised cosine window, a Hamming window, a Chebyshev window, a rectangular window, a triangular window, etc. The windowing may reduce ripple effect in the frequency response of the pseudo-whitening filter. The spectral leakage may also be reduced by smoothing the filter gains in the frequency domain prior to perform the IDFT to obtain the time-domain values. For example, the smoothing may be achieved by averaging the filter gains for the large interference peaks with adjacent filter gains. The windowing in the time domain and the smoothing in the frequency domain may also be omitted.

FIR filter 520 receives the filter coefficients from unit 518 and the input samples used to derive these filter coefficients. FIR filter 520 convolves or filters the input samples based on the filter coefficients and provides filtered samples to searcher 522. Searcher 522 may process the filtered samples in the normal manner to detect for the PSC and SSCs.

In one design, which is described above, the filter coefficients are computed in each time interval based on the input samples for that time interval and then used to filter these input samples. The duration of the time interval determines the update rate of the filter coefficients. Interference that lasts less than one time interval may not be captured in the PSD and hence may not be attenuated by the filter coefficients. The time interval may be selected to be sufficiently short in order to capture fast changing interference.

The bin width determines the frequency resolution of the PSD. Interference that is narrower than the bin width may not be captured by the PSD and attenuated by the filter coefficients. The bin width may be selected to be sufficiently narrow in order to capture all potential narrowband interference of interest.

In the design shown in equation (5), the filter gains are varied from a nominal value of 1 only when a large interference peak is detected. Furthermore, the filter gains are varied by an amount that is inversely related to the magnitude of the interference peak. When large interference peaks are not present, the filter gains are all ones, and the input samples are not filtered. This design may thus improve detection performance (e.g., reduce probability of false alarm) for operating scenarios in which large interference peaks are present without impacting detection performance (e.g., maintain probability of detection) for other operating scenarios in which large interference peaks are not present.

In one design, the filter coefficients are derived anew in each time interval based on the input samples for that time interval. In another design, the filter coefficients for each time interval are derived based on the input samples for that time interval and one or more prior time intervals. In yet another design, the filter coefficients are derived in an adaptive manner and updated in each time interval based on the input samples for that time interval. The updating of the filter coefficients may be based on any adaptive technique such as linear minimum mean square error (LMMSE), least mean square (LMS), recursive least square (RLS), direct matrix inversion (DMI), zero-forcing, etc. LMS, RLS, and DMI are described by Simon Haykin in a book entitled “Adaptive Filter Theory”, 3rd edition, Prentice Hall, 1996.

In the design described above, large interference peaks are detected in the frequency domain and attenuated in the time domain with a FIR filter that implements a pseudo-whitening filter. In general, large interference peaks may be (1) detected in either the time domain or the frequency domain and (2) attenuated in either the time domain or the frequency domain. For time-domain detection, the input samples may be filtered with a bank of narrowband filters at different center frequencies, and the power of the filtered samples from each narrowband filter may be compared against a threshold to determine whether or not large interference is present in the frequency bin corresponding to that narrowband filter. For frequency-domain attenuation, the input samples may be transformed to the frequency domain, and large spectral components corresponding to interference may be attenuated in the frequency domain. In general, the filter coefficients used for attenuating large interference peaks may be time-domain coefficients or frequency-domain coefficients.

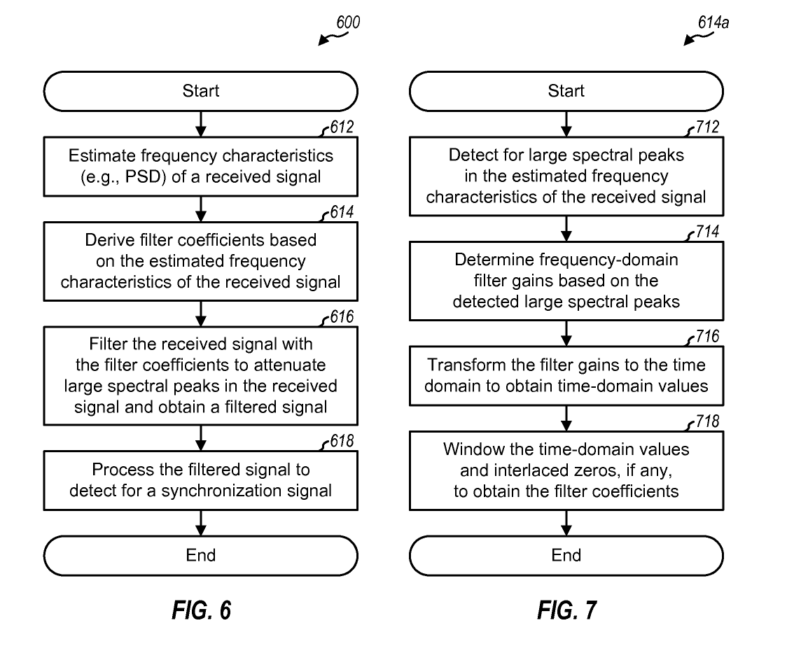

FIG. 6 shows a design of a process 600 for detecting for a synchronization signal in a wireless communication system. Frequency characteristics (e.g., the PSD) of a received signal may be estimated (block 612). Filter coefficients may be derived based on the estimated frequency characteristics of the received signal (block 614). The received signal may be filtered based on the filter coefficients to attenuate large spectral peaks (may correspond to interference) in the received signal and obtain a filtered signal (block 616). The filter coefficients may have a flat frequency response when large spectral peaks are not detected in the received signal. The filtered signal may be processed to detect for a synchronization signal (block 618). For block 618, the filtered signal may be correlated with a locally generated synchronization code (e.g., a PSC in W-CDMA) at different time offsets to detect for the synchronization signal.

The frequency characteristics of the received signal may be estimated in each time interval. The filter coefficients may be determined anew or may be updated in each time interval. The received signal for each time interval may be filtered based on the filter coefficients for that time interval to obtain the filtered signal for the time interval.

FIG. 7 shows a design of a process 614a for deriving the filter coefficients. Process 614a may be used for block 614 in FIG. 6. Large spectral peaks in the estimated frequency characteristics of the received signal may be detected (block 712). Frequency-domain filter gains may be determined based on the detected large spectral peaks (block 714). For example, the filter gain for each of multiple frequency bins may be set to (1) a predetermined value if a large spectral peak is not detected in the frequency bin or (2) a value that is inversely related to the amplitude of the large spectral peak if it is detected in the frequency bin. The filter gains for all frequency bins may be transformed to time domain to obtain time-domain values (block 716). The frequency characteristics and the filter gains may be determined based on input samples at a first rate, and the filter coefficients may be derived for input samples at a second rate that is different from the first rate. In this case, the time-domain values may be interlaced with zeros to convert from the first rate to the second rate. The time-domain values and the interlaced zeros, if any, may be windowed to obtain the filter coefficients (block 718).

The PSD of the received signal may be determined in order to estimate the frequency characteristics of the received signal. For example, the autocovariance of the received signal may be determined and transformed to the frequency domain to obtain the PSD of the received signal. For block 714, large peaks in the PSD may be detected, e.g., by comparing each PSD value against a threshold and declaring a large peak for each PSD value exceeding the threshold. The threshold may be determined based on an average PSD value (or PSD floor), which may be determined based on a predetermined percentage (e.g., 70%) of the smallest PSD values. The filter coefficients may then be determined based on the detected large peaks in the PSD.

The detection techniques described herein may improve detection performance for operating scenarios with large amplitude interference. Test results show that the techniques may be able to reduce false alarm probability from 100% to 0% or a small percentage in some cases. No degradation in probability of detection was observed with the techniques. Reducing false alarms in step-1 search may save search time that would have been spent in step-2 search. Since step-1 search may be performed on multiple frequencies and multiple step-1 false alarms may occur per frequency, the time savings resulting from reducing step-1 false alarms may be significant.

The detection techniques may provide various advantages. First, the techniques may improve search time by reducing the number of step-2 searches due to step-1 false alarms. Second, the techniques may improve battery life. The techniques may be especially beneficial for searches performed at power up, during out-of-service condition, etc. These are times when a UE may be more likely to encounter lack of W-CDMA signals and conditions that can cause high probability of step-1 false alarms.

The detection techniques described herein may be implemented by various means. For example, these techniques may be implemented in hardware, firmware, software, or a combination thereof. For a hardware implementation, the processing units used to perform the techniques may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

For a firmware and/or software implementation, the techniques may be implemented with modules (e.g., procedures, functions, etc.) that perform the functions described herein. The firmware and/or software instructions may be stored in a memory (e.g., memory 482 in FIG. 4) and executed by a processor (e.g., processor 480). The memory may be implemented within the processor or external to the processor. The firmware and/or software instructions may also be stored in other processor-readable medium such as random access memory (RAM), read-only memory (ROM), non-volatile random access memory (NVRAM), programmable read-only memory (PROM), electrically erasable PROM (EEPROM), FLASH memory, compact disc (CD), magnetic or optical data storage device, etc.

An apparatus implementing the techniques described herein may be a stand-alone unit or may be part of a device. The device may be (i) a stand-alone integrated circuit (IC), (ii) a set of one or more ICs that may include memory ICs for storing data and/or instructions, (iii) an ASIC such as a mobile station modem (MSM), (iv) a module that may be embedded within other devices, (v) a cellular phone, wireless device, handset, or mobile unit, (vi) etc.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus comprising:
at least one processor configured to estimate frequency characteristics of a received signal, to derive filter coefficients based on the estimated frequency characteristics of the received signal, to filter the received signal based on the filter coefficients to attenuate large spectral peaks in the received signal and obtain a filtered signal, and to process the filtered signal to detect for a synchronization signal; and
a memory coupled to the at least one processor.

2. The apparatus of claim 1, wherein the synchronization signal is part of a spread spectrum signal having a flat spectral response, and wherein the large spectral peaks correspond to interference.

3. The apparatus of claim 1, wherein the at least one processor is configured to determine a power spectral density (PSD) of the received signal, to detect for large peaks in the PSD, and to derive the filter coefficients based on the detected large peaks in the PSD.

4. The apparatus of claim 3, wherein the at least one processor is configured to determine autocovariance of the received signal and to transform the autocovariance of the received signal to frequency domain to obtain the PSD of the received signal.

5. The apparatus of claim 3, wherein the at least one processor is configured to determine an average value of the PSD without the large peaks, to determine a threshold based on the average value of the PSD, to compare values of the PSD against the threshold, and to declare a large peak for each value of the PSD exceeding the threshold.

6. The apparatus of claim 5, wherein the at least one processor is configured to determine the average value of the PSD based on a predetermined percentage of smallest values of the PSD.

7. The apparatus of claim 1, wherein the at least one processor is configured to detect for large spectral peaks in the estimated frequency characteristics of the received signal, to determine frequency-domain filter gains based on the detected large spectral peaks, and to derive the filter coefficients based on the frequency-domain filter gains.

8. The apparatus of claim 7, wherein the at least one processor is configured to set a filter gain for each of a plurality of frequency bins to a predetermined value if a large spectral peak is not detected in the frequency bin and to a value inversely related to the large spectral peak if detected in the frequency bin.

9. The apparatus of claim 7, wherein the at least one processor is configured to transform the frequency-domain filter gains to time domain to obtain the filter coefficients.

10. The apparatus of claim 7, wherein the at least one processor is configured to transform the frequency-domain filter gains to time domain to obtain time-domain values, and to window the time-domain values to obtain the filter coefficients.

11. The apparatus of claim 7, wherein the at least one processor is configured to transform the frequency-domain filter gains to time domain to obtain time-domain values, to interlace the time-domain values with zeros, and to window the time-domain values and the interlaced zeros to obtain the filter coefficients.

12. The apparatus of claim 7, wherein the at least one processor is configured to estimate the frequency characteristics of the received signal and determine the frequency-domain filter gains based on input samples at a first rate, to derive the filter coefficients for input samples at a second rate different from the first rate, and to filter the input samples at the second rate based on the filter coefficients.

13. The apparatus of claim 1, wherein the filter coefficients have a flat frequency response when large spectral peaks are not detected in the received signal.

14. The apparatus of claim 1, wherein the at least one processor is configured to estimate the frequency characteristics of the received signal and derive the filter coefficients in each time interval, and to filter the received signal for each time interval based on the filter coefficients derived for the time interval to obtain the filtered signal for the time interval.

15. The apparatus of claim 1, wherein the at least one processor is configured to correlate the filtered signal with a locally generated synchronization code at different time offsets to detect for the synchronization signal in the received signal.

16. The apparatus of claim 15, wherein the synchronization code is a primary synchronization code (PSC).

17. A method comprising:
estimating frequency characteristics of a received signal;
deriving filter coefficients based on the estimated frequency characteristics of the received signal;
filtering the received signal based on the filter coefficients to attenuate large spectral peaks in the received signal and obtain a filtered signal; and
processing the filtered signal to detect for a synchronization signal.

18. The method of claim 17, wherein the estimating the frequency characteristics of the received signal comprises determining a power spectral density (PSD) of the received signal, and wherein the deriving the filter coefficients comprises
detecting for large peaks in the PSD, and
deriving the filter coefficients based on the detected large peaks in the PSD.

19. The method of claim 17, wherein the deriving the filter coefficients comprises
detecting for large spectral peaks in the estimated frequency characteristics of the received signal,
determining frequency-domain filter gains based on the detected large spectral peaks, and
deriving the filter coefficients based on the frequency-domain filter gains.

20. The method of claim 19, wherein the determining the frequency-domain filter gains based on the detected large spectral peaks comprises
setting a filter gain for each of a plurality of frequency bins to a predetermined value if a large spectral peak is not detected in the frequency bin and to a value inversely related to the large spectral peak if detected in the frequency bin.

21. The method of claim 19, wherein the deriving the filter coefficients based on the frequency-domain filter gains comprises
transforming the frequency-domain filter gains to time domain to obtain time-domain values, and
windowing the time-domain values to obtain the filter coefficients.

22. An apparatus comprising:
means for estimating frequency characteristics of a received signal;
means for deriving filter coefficients based on the estimated frequency characteristics of the received signal;
means for filtering the received signal based on the filter coefficients to attenuate large spectral peaks in the received signal and obtain a filtered signal; and
means for processing the filtered signal to detect for a synchronization signal.

23. The apparatus of claim 22, wherein the means for estimating the frequency characteristics of the received signal comprises means for determining a power spectral density (PSD) of the received signal, and wherein the means for deriving the filter coefficients comprises
means for detecting for large peaks in the PSD, and
means for deriving the filter coefficients based on the detected large peaks in the PSD.

24. The apparatus of claim 22, wherein the means for deriving the filter coefficients comprises
means for detecting for large spectral peaks in the estimated frequency characteristics of the received signal,
means for determining frequency-domain filter gains based on the detected large spectral peaks, and
means for deriving the filter coefficients based on the frequency-domain filter gains.

25. The apparatus of claim 24, wherein the means for determining the frequency-domain filter gains based on the detected large spectral peaks comprises
means for setting a filter gain for each of a plurality of frequency bins to a predetermined value if a large spectral peak is not detected in the frequency bin and to a value inversely related to the large spectral peak if detected in the frequency bin.

26. The apparatus of claim 24, wherein the means for deriving the filter coefficients based on the frequency-domain filter gains comprises
means for transforming the frequency-domain filter gains to time domain to obtain time-domain values, and
means for windowing the time-domain values to obtain the filter coefficients.

27. A processor-readable media for storing instructions to:
estimate frequency characteristics of a received signal;
derive filter coefficients based on the estimated frequency characteristics of the received signal;
filter the received signal based on the filter coefficients to attenuate large spectral peaks in the received signal and obtain a filtered signal; and
process the filtered signal to detect for a synchronization signal.

28. The processor-readable media of claim 27, and further for storing instructions to:
determine a power spectral density (PSD) of the received signal,
detect for large peaks in the PSD, and
derive the filter coefficients based on the detected large peaks in the PSD.

29. The processor-readable media of claim 27, and further for storing instructions to:
detect for large spectral peaks in the estimated frequency characteristics of the received signal,
determine frequency-domain filter gains based on the detected large spectral peaks, and
derive the filter coefficients based on the frequency-domain filter gains.

30. The processor-readable media of claim 29, and further for storing instructions to:
set a filter gain for each of a plurality of frequency bins to a predetermined value if a large spectral peak is not detected in the frequency bin and to a value inversely related to the large spectral peak if detected in the frequency bin.

31. The processor-readable media of claim 29, and further for storing instructions to:
transform the frequency-domain filter gains to time domain to obtain time-domain values, and
window the time-domain values to obtain the filter coefficients.
